(19) United States
(12) Patent Application Publication
(10) Pub. No.: US 2004/0190901 A1
(43) Pub. Date: Sep. 30, 2004

(54) Bi-directional optical network element and its control protocols for WDM rings

(76) Inventor: Xiaojun Fang, San Jose, CA (US)

Correspondence Address: Xiaojun Fang, Apt. 15, 1040 S Winchester Blvd., San Jose, CA, 95128, US

(21) Appl. No.: 10/402,703

(22) Filed: Mar. 29, 2003

(51) Int. Cl. H04J 14/00

(52) U.S. Cl. 398/59; 398/83

(57) ABSTRACT

This invention is an optical network element (ONE) for bi-directional WDM ring networks. It consists of a west-side bi-directional OADM 400, an east-side bi-directional OADM 405, two west-side optical multiplexer/demultiplexer pairs 440 and 445, and two east-side optical multiplexer/demultiplexer pairs 450 and 455. Dynamic optical switching between different bi-directional optical ports is accomplished by a 1-dimentional analog MEMS channel mirror array. The optical network element supports dynamic bi-directional wavelength add-drop, optical layer protection switching on per wavelength basis, and optical channel loopback, etc.

### FIELD OF THE INVENTION

This invention relates generally to optical networking, in particular to a method and a device to manage wavelength connections in WDM networks. More specifically, it relates a bi-directional optical network element that uses 1-dimensional MEMS mirror arrays for wavelength switching.

### BACKGROUND AND SUMMARY OF THE INVENTION

Traditional optical transport network is based on Synchronous Optical Network (SONET) or Synchronous Digital Hierarchy (SDH). The SONET/SDH network is a time-division-multiplexing (TDM) network, where multiple 810-byte STS-1/STM-0 frames are multiplexed into 125-microsecond transmission frames. The bandwidth granularity in the SONET network is STS-1 (51.83 Mbps), and bandwidth management is accomplished by assigning different number of STS-1 tributaries to a service connection. Total bandwidth of the SONET network is determined by its line rate. The TDM-based SONET network has reached its speed limit, hence the core optical network is migrating from the SONET/SDH based TDM network to a new optical transport network (OTN) based WDM network. Bandwidth management in the OTN network is accomplished by managing wavelength connections.

The most common optical network topology is the ring. This is because the ring network has good survivability and management simplicity compared to the mesh network or the linear network. A SONET/SDH ring consists of multiple add-drop multiplexers (ADM) that are connected by 2 or 4 fibers to form a self-healing bi-directional ring network. Each SONET ADM node adds, drops, or bypasses STS-1 tributaries, and performs automatic protection switching (APS) to restore the failed connections during a failure. Similarly, a WDM ring consists of multiple optical network elements (ONE) that are connected bi-directionally by 2 fibers. One fiber ring carries wavelengths along the clockwise direction and the other fiber carries wavelengths along the counterclockwise direction. In order to perform optical layer automatic protection and dynamic wavelength add and drop, the ONE contains an optical switching fabric. The most advanced optical switching technology today is the micro-electromechanical systems (MEMS) technology. Current optical switching fabric for the ONE application includes the 2-dimensional (2D) MEMS mirror matrix and 3-dimensional (3D) MEMS mirror matrix. These MEMS mirror matrices are big, unreliable, and very expensive. It has only be deployed in the core optical cross-connect switch application due to cost and size limitations. Recently, the 1-dimensional (1D) analog MEMS mirror array is developed for multiple-port dynamic optical add-drop multiplexer (OADM) modules. The 1D MEMS mirror array is a much simpler component than the 2D or 3D MEMS mirror matrix. The 1D analog MEMS mirror array is used in this invention as a simple optical switching fabric to build a fully functional ONE node.

The OADM module based on the 1D MEMS mirror array is to dynamically add, drop and bypass wavelengths in a fiber. Because the OADM module is a component for a WDM fiber, it is built as a unidirectional device. However, the ONE node in the bi-directional WDM ring manages bi-directional wavelength connections. To achieve this goal in a cost-effect way, the OADM module is designed as a bi-directional device in this invention. The ONE node contains two 1D MEMS based bi-directional OADMs as its optical switching fabric. It supports dynamic wavelength add and drop, optical layer automatic protection switching on per wavelength basis (O-APS), optical channel loopback (OCH-LB), optical performance monitoring, and optical connection management, etc.

Because the 1D MEMS-based OADM device is based on free-space optics, it has long optical path length and large beam diameter. Active optical alignment is often necessary to lock the OADM component to its optimal operation point. This is accomplished by using another MEMS mirror array in front of the input/output optical ports of the device for automatic optical alignment. Since each alignment mirror on the array is correspondent to an optical port, this alignment mirror array is called the port mirror array of the OADM. Optical performance of the OADM is sensitive to the optical alignment. An effective servo control method to automatically align the optical ports to optimal is important.

The present invention is a bi-directional optical network element (ONE) for the WDM ring network. The 1D analog MEMS channel mirror array and the 2D MEMS-port mirror array in the OADM of precious arts are used to build the bi-directional OADM for the ONE node. Each ingress port is paired with an egress port to form a bi-directional port in the bi-directional OADM, and these bi-directional ports are symmetrically distributed along a linear array to achieve symmetry. Standard dither based servo scheme can be used to align the port mirrors automatically. A ONE node contains two bi-directional OADM modules as its east-side optical network-network interfaces (O-NNI) and its west-side optical network-network interface. The ONE node also has four optical multiplexer-demultiplexer (OMUX/ODMUX) pairs as its optical user-network interfaces (O-UNI) to combine or separate WDM wavelengths. A bi-directional wavelength connection can be terminated by a transponder in the ONE node, or connected transparently to another WDM ring to form a multiple-ring wavelength connection. A multi-ring wavelength connection can also be a virtual-wavelength connection, where the wavelength is converted to a new wavelength by a transponder before entering another WDM ring. Automatic protection switching (APS) is supported by the ONE, and APS signaling can be carried by the OCH overhead and the optical supervisory channel (OSC). Ring interconnect is done by cross-connecting OADM modules of different ONEs through their add/drop ports.

### BRIEF DESCRIPTION OF THE FIGURES

FIG. 1A shows the functional block diagrams of three unidirectional OADM modules of previous arts;

FIG. 1B shows the optical architecture of the OADM of the previous art using an analog 1D MEMS array, a bulk grating, and an optional 2D MEMS array for port alignment;

FIG. 2 shows the port mirror servo and the channel mirror switch control architecture of the OADM;

FIG. 3 shows the ITU grid marker mirror for the port mirror servo control;

FIG. 4 is the flow-chart of the automatic optical alignment algorithm for the MEMS mirrors in the OADM;

FIG. 5 shows the channel wavelength plan of the 2-fiber WDM ring network, where the solid lines represent working wavelength and the dotted lines represent protection wavelengths;

FIG. 6 is the architecture of a standard ONE node consisting of two bi-directional OADM modules, four OMUX/ODMUX modules, and a plurality of transponders for optical termination,

FIG. 7 shows the port arrangement and the internal wavelength connectivity of the bi-directional OADM module in its normal state (FIG. 7A) and in its protection switching state (FIG.7B);

FIG. 8 illustrates an example of the optical layer protection switching during a fiber cut between the node 600 and the node 620; the failed connection is restored through the diverse path of the ring using the protection wavelength;

FIG. 9 is the flow-chart of the optical layer automatic protection switching control algorithm;

FIG. 10 is the architecture of ring interconnection, where the correspondent nodes are interconnected through the bi-directional add/drop ports of the OADM modules. The whole system is a distributed optical cross-connect switch;

FIG. 11 is the architecture of the dual-side bi-directional OADM.

### DETAILED DESCRIPTION

The present invention is a method to build an optical network element (ONE) node 2-fiber bi-directional WDM ring networks. This ONE node uses the 1-dimensional micro-ectromechanical systems (MEMS) mirrors as its optical switching elements. The MEMS mirrors are switched to the correct angle through open-loop switching, and a standard dither based servo scheme can be used to fine-tune each MEMS mirror to improve the optical performance. Two bi-directional OADM modules are used in a ONE node as the two optical network-network interfaces (O-NNI), and four optical multiplexer/demultiplexer (OMUX/ODMUX) modules are used as the optical user-network interfaces (O-UNI). The bi-directional OADM module uses a 1-dimentional analog MEMS mirror array for bi-directional wavelength switching. The bi-directional ONE node supports dynamic wavelength add-drop, per wavelength optical layer automatic protection switching, and optical channel loopback on per channel basis, etc.

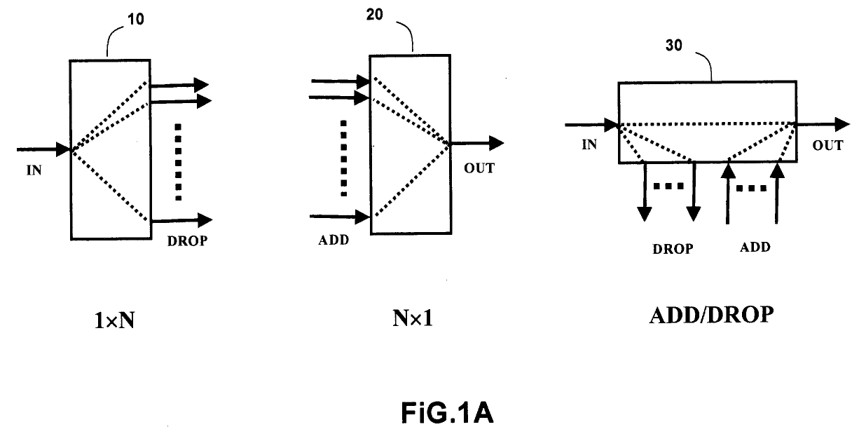

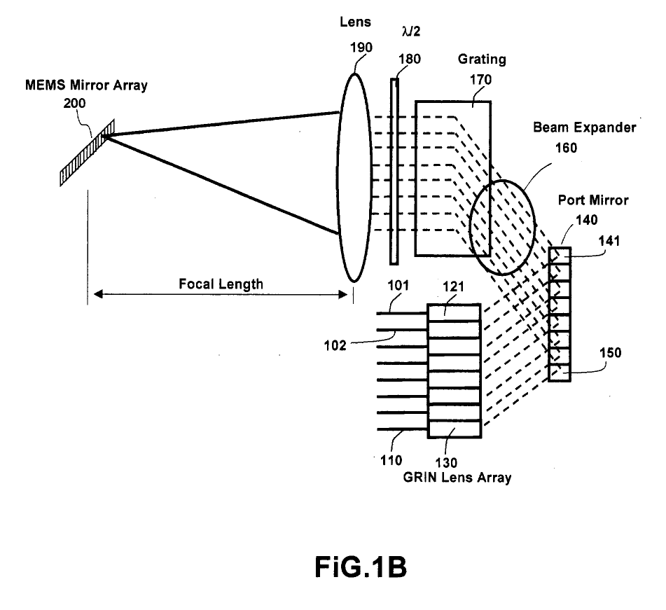

The 1D analog MEMS mirror array provides per wavelength switching between any ingress port to any egress port. The three conventional OADMs in the previous arts that use the 1D analog MEMS mirror array for wavelength switching are shown in FIG. 1A. The 1×N device 10 is also called a wavelength router, because it can switch any input wavelength to any output port dynamically. The N×1 device 20 is an optical combiner. It has noise rejection and selective wavelength blocking capability. The OADM device 30 has an input port, an output port, N/2-1 add ports, and N/2-1 drop ports. Each port can pass any number of wavelengths.

Optical architecture of the 1D MEMS mirror array based OADM in the previous art is shown in FIG. 1B. It has multiple optical ports 101 to 110. The fiber of each port is coupled to a graded refractive index lens (GRIN lenses, 121 to 130) to transform the light from the fiber to a free-space narrow parallel beam, or to couple the output parallel beam into the fiber. A MEMS port mirror array 140 is used for automatic optical alignment to relieve the difficulty for passive optical alignment. Each port mirror on the array 140 is a 2-dimensional (2D) MEMS mirror and corresponds to an input or output port. By tuning the port mirror reflection angle, optimal optical coupling can be achieved. Input WDM signal is injected into the OADM through the fiber 101 and transformed to a parallel beam by the GRIN lens 121. The WDM input light is reflected by the port mirror 141 toward the grating 170. The beam expander 140 expands the narrow input beam to a wide parallel beam to achieve better spectrum resolution for the OADM. The grating 170 reflects the input WDM beam with strong dispersion, and the dispersed WDM beam is focused by the focusing lens 190 onto the analog 1D MEMS channel mirror array 200 on the focal plane. The MEMS channel mirror array 200 has multiple 1D MEMS mirrors, each for an ITU grid input wavelength. Each channel mirror is controlled by an electrical drive signal to different angle. An input wavelength can be reflected to an output port by setting a reflection angle for the mirror. The half-wave plate 180 is to balance the polarization dependent loss (PDL) for the grating. Each ITU grid input wavelength is focused onto the center of a channel mirror on the array 200. The ITU grid matching is accomplished by selecting accurate zooming factor and grating period to match the ITU grid spatial spectral period with the MEMS channel mirror size. The ITU input wavelength spot is further adjusted to the center of the channel mirror by adjusting the input port mirror 141. The input port ITU grid alignment needs a very accurate control, and there is no reliable method available yet. In addition, output port mirrors also need to be aligned at all time with or without the out put WDM signal. This cannot be done in the previous arts.

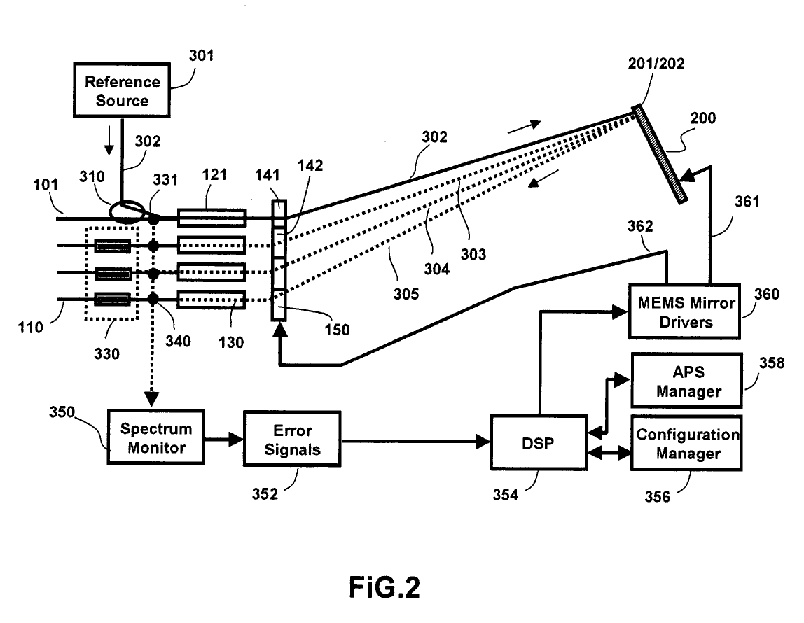

A dither based port mirror servo architecture for automatic port mirror alignment is illustrated in FIG. 2. Each 2D port mirror has two factory-calibrated open-loop drive voltages for optimal alignment, one per axis. The drive voltages need to be adjusted slightly to compensate aging and temperature-induced drifts. A reference wavelength source 301 is used for the port mirror servo. This reference wavelength is injected into an input port of the OADM module through the link 302. A wavelength multiplexer 310 is used to combine the reference wavelength with the incoming WDM signal from the input fiber. The combined signal then passes a directional fiber coupler 331 (black dot) and is transformed to a parallel beam by the GRIN lens 121. The input port used for injecting the reference wavelength is the master port for the port mirror servo, all other ports are slave ports. The fiber of each port connects to a directional fiber coupler which taps a small portion of the output light from the OADM module for monitoring. This optical monitoring signal is sent to the spectrum monitor 350 for analysis. Optical monitoring signals from different ports can be combined by an optical combiner and then sent to the spectrum monitor 350. The spectrum monitor 350 detects existence and power of each ITU wavelength. If the wavelength is intensity modulated by a dither tone, the AC component of this intensity signal will be used for the servo control to lock the optical coupling to the peak of the coupling curve. All the ports have an optional wavelength blocking device 330 (such as fiber Bragg gratings or optical thin-film filters) to block the reference wavelength from entering the optical network. The collimated reference wavelength of link 302 is incident on the port mirror 141 and reflected. It travels through the free-space optical components shown in FIG. 1B and is eventually focused onto the ITU marker mirror 201 or 202 on the 1D MEMS mirror array 200. The ITU marker mirror 201/202 is used to align the master input port. Because the reference light is accurate ITU grid wavelength, by aligning the reference wavelength to the center of the ITU marker mirror will also align all input ITU gird wavelengths to the center of correspondent channel mirrors.

The reference wavelength is first reflected back to the master port mirror 141 by the ITU marker mirror and coupled to the fiber. A small portion of the reflected light is tapped out and converted to an electrical signal by the spectrum monitor 350. The port mirror 141 is dithered by a sine wave of low amplitude that is overlaid on top of the open-loop drive voltage. The master port mirror dither introduces light spot movement on the ITU marker mirror, which results in intensity modulation on the reflected reference light. The electrical signal from the spectrum monitor is used to generate error signal for the dither-based control loop, and this error signal 352 is sent to the digital signal processor (DSP) 354 for processing. The port mirror will be locked to the top of the coupling curve by the servo loop. This means the reference wavelength is aligned to the center of the ITU marker mirror, and ITU alignment for the master port is accomplished. The system will then used the optimal drive voltage obtained from the servo to drive the master port mirror 141 in open-loop fashion.

After the master port mirror is aligned, the OADM device will align each slave port automatically one by one. The ITU marker mirror 201/202 will be set to a new angle by the configuration manager, to reflect the reference wavelength from the master port to the first slave port mirror 142 through the path 303. This reflected reference light is coupled to the fiber. A small portion of the reflection light 303 is tapped out and analyzed by the spectrum monitor 350. The slave port mirror 142 is dithered by a sine signal during the slave port servo process to introduce intensity modulation. By using the standard dither scheme, the slave port mirror 142 will be automatically tuned to the top of the coupling curve relative to the master port. After the two new optimal open-loop drive voltages are found, the OADM device will use the new optimal drive voltages to drive the slave port in open-loop. Other slave ports can be fine-tuned to the optimal coupling point relative to the master port one by one in this way. This port mirror servo scheme uses a single reference wavelength to automatically align both the input ports and the output ports.

The configuration manager 356 in FIG. 2 provides correct open-loop drive voltage values to the MEMS mirror driver 360. The MEMS mirror drivers 360 convert the open-loop drive voltage values into high voltages to drive the MEMS mirrors. Each channel mirror has an open-loop drive voltage matrix obtained from factory calibration. The configuration manager 356 determines what open-loop drive voltage value to use to reflect a wavelength from an input port to an output port. The APS manager 358 handles APS signaling and channel mirror open-loop switching sequence during the automatic protection switching. Switching of channel mirrors is done in the open-loop manner. If good athermal design and the passive optical port alignment can achieved with good long-term stability for the 1D MEMS based OADM, the active port alignment servo scheme through the MEMS port mirrors is optional.

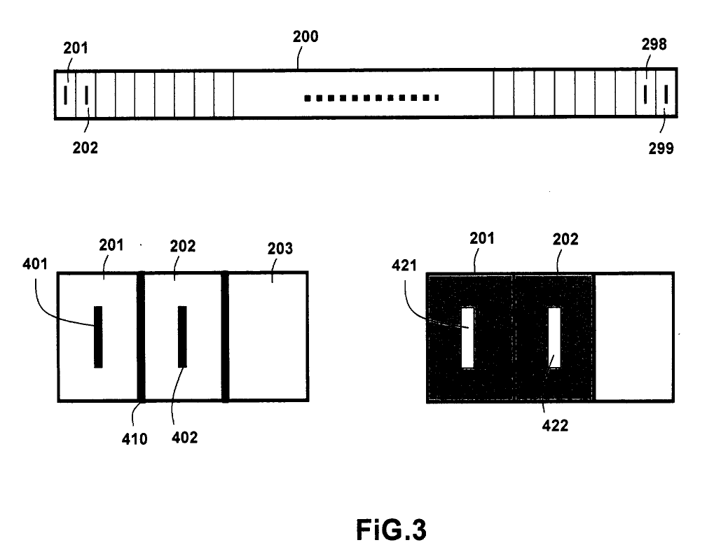

The ITU marker mirror for the port mirror servo control is shown in FIG. 3. The ITU marker mirrors 201 and 202 are on the edge of the MEMS channel mirror array 200. There are two versions of the ITU marker mirror, the negative markers 401 and 402, and the positive markers 421 and 422. The servo will lock the master port to the dip of the coupling curve in the negative marker case, or lock the master port to the peak of the coupling curve in the positive marker case. The negative marker 410 is the gap between the two channel mirrors 201 and 202, which can also be used for the master port ITU alignment along the wavelength direction.

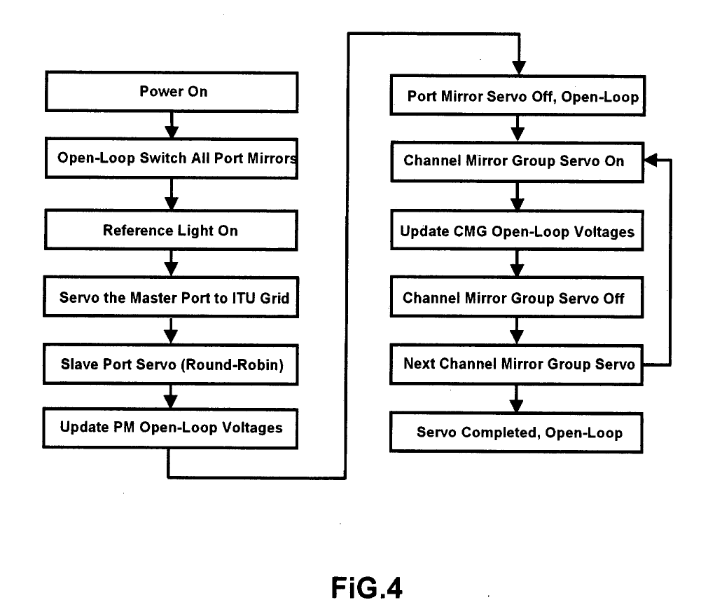

Each MEMS channel mirror has an open-loop switch voltage matrix stored in the configuration manager database. Switching of channel mirrors is done by open-loop switching followed by the dither-based servo scheme for fine-tuning. The servo control algorithm for both the port mirrors and the channel mirrors is shown in FIG. 4. All mirrors are switched and maintained in the open-loop mode, and the servo is used only for periodic tuning to compensate long-term drifts. When an incoming wavelength is reflected by a channel mirror to an egress port, the reflection angle of the channel mirror can also be fine-tuned to achieve maximum coupling by dithering servo loop.

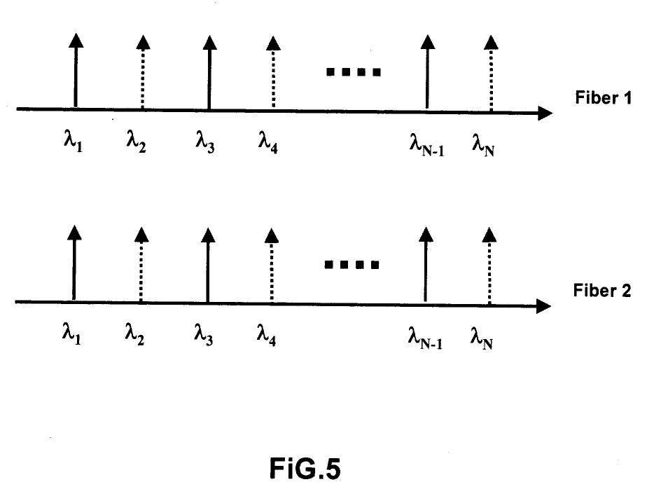

The channel wavelength plan for the 2-fiber bi-directional WDM ring is shown in FIG. 5, where the solid lines represent wavelengths for working connections and the dotted lines represent wavelengths for protection connections. A bi-directional working wavelength connection uses the same wavelength in both fibers, it can be protected by a bi-directional protection wavelength connection. Since some optical connections do not need protection, the exact wavelength plan may vary from case to case. During the optical layer protection switching, the protection wavelength for the failed working wavelength will be lit and it will go along the opposite direction in the ring to reestablish the connection. In case there is no protection transponder in the ONE node for protection switching, the working transponder needs to be tuned to the protection wavelength.

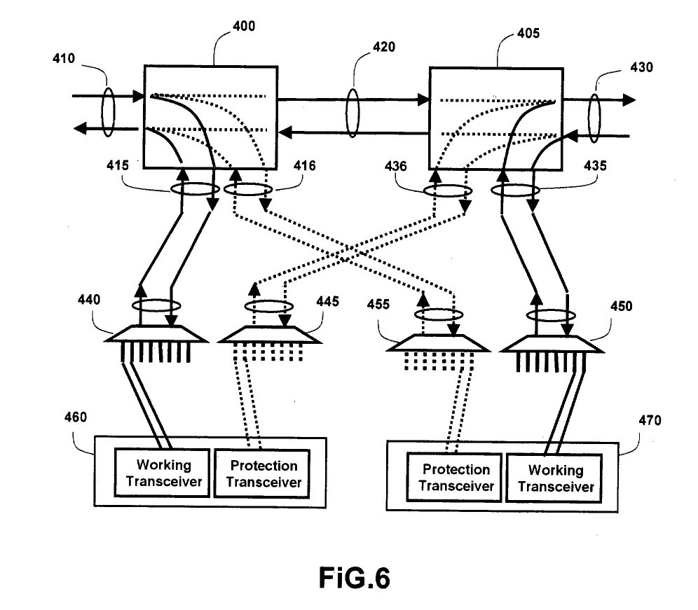

The architecture of the standard ONE node is shown in FIG. 6. The ONE node consists of a west-side bi-directional OADM 400, an east-side bi-directional OADM 405, a west-side working OMUX/ODMUX 440, a west-side protection OMUX/ODMUX 445, an east-side working OMUX/ODMUX 450, and an east-side protection OMUX/ODMUX 455. There is a plurality of optional WDM transponders in the ONE node for optical path termination. The working transponders may have redundant transponders for equipment protection. The transponder protection scheme can be 1:1, 1:N, or 0:1, depends on reliability requirements. The west-side working transponders are connected to the west-side working OMUX/ODMUX 440, and the west-side protection transponders are connected to the west-side protection OMUX/ODMUX 445. The east-side working transponders are connected to the east-side working OMUX/ODMUX 450, and the east-side protection transponders are connected to the east-side protection OMUX/ODMUX 455. The bi-directional OADM 400 and 405 are the optical switching elements based on the 1D analog MEMS mirror array described in the previous sections. But its ingress ports and egress ports are paired into bi-directional ports and arranged symmetrically along the port array. The bi-directional OADM handles wavelength connections bi-directionally.

The west-side OADM 400 has a bi-directional input/output port 410, a bi-directional express input/output port 420, and a plurality of bi-directional add/drop ports. It has at least a bi-directional working wavelength add/drop port 415 and a bi-directional protection wavelength add/drop port 416. The OADM 405 also has at least a bi-directional working wavelength add/drop port 435 and a bi-directional protection wavelength add/drop port 436. The express input/output ports 420 of the two OADMs are connected to bypass the express wavelength channels. The east-side protection OMUX/ODMUX 455 is connected to the protection add/drop port 416 of the west-side OADM, and the west-side protection OMUX/ODMUX 445 is connected to the east-side protection add/drop port 436 of the east-side OADM. Express optical channels are connected from the west-side input/output port 410 to the east-side input/output port 430 to bypass the ONE node. A protection wavelength is connected by the OADM either between the input/output port and the express input/output port, or between the input/output port and the protection add/drop port, as shown by the dotted lines inside the OADM in FIG. 6.

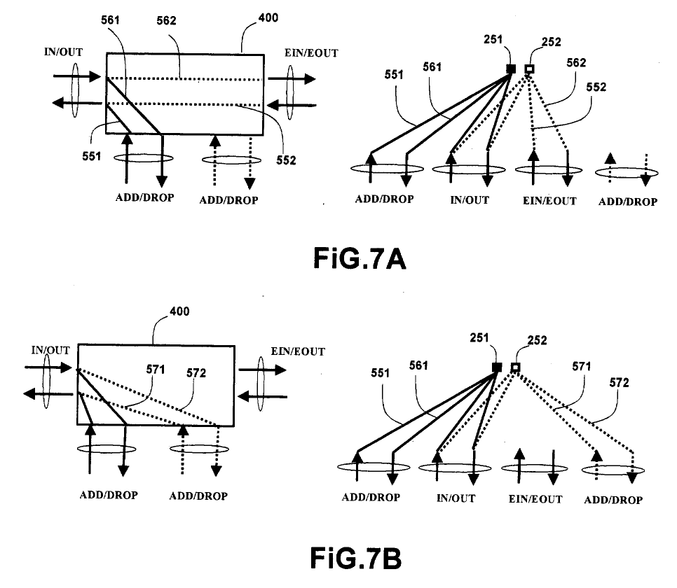

The bi-directional OADM modules in FIG. 6 are also based on the optical architecture in FIG. 1B or FIG. 2. However, the bi-directional OADM only handles bi-directional wavelength connections by utilizing the port symmetry to achieve simultaneous reflection between multiple ingress-ingress ports for the same wavelength. The bi-directional OADM also supports optical loopback by reflecting the light from an ingress port to the egress port of the same bi-directional port. The symmetric port arrangement scheme is shown in FIG. 7. The ports 101 to 110 in FIG. 1B or FIG. 2 are alternatively assigned as ingress port and egress port. An ingress port is paired with its adjacent egress port to form a bi-directional port (indicated by a circle). These bi-directional ports are evenly distributed along the linear port array. This port symmetry results in concurrent reflection of two light beams (of a bi-directional connection) by the same channel mirror.

The bi-directional OADM 400 has a plurality of add/drop ports, an input/output port, and an express input/output port. The internal wavelength connections in its normal state are shown in FIG. 7A, where only a working wavelength and a protection wavelength are shown for simplicity. All other working and protection wavelengths can be controlled in the same way. The solid lines indicate the working wavelength connections, while the dotted lines indicate the protection wavelength connections. The MEMS channel mirror 251 reflects the working wavelength from the input port to the drop port through path 561, and it concurrently reflects the working wavelength from the add port to the output port through path 551. This concurrent transmission along opposite direction comes from the symmetry of the port arrangement. Similarly, the MEMS channel mirror 252 reflects the protection wavelength from the input/output port to the express input/output port through paths 552 and 562. During the optical protection switching, the protection wavelength is connected between the input/output port and the protection add/drop port through paths 571 and 572, as shown in FIG. 7B. This is accomplished by rotating the channel mirror 252 to a new reflection angle. All other wavelengths can be connected between any two bi-directional ports independently in similar way. It is easy to see that optical channel loopback can be accomplished by rotating the channel mirror to reflect the ingress wavelength from the ingress port back to the egress port of the same bi-directional port. The bi-directional OADM supports bi-directional wavelength connections between any two bi-directional ports, or from the ingress port to the egress port of the same bi-directional port for optical loopback. All these are accomplished by rotating the correspondent channel mirrors to the correct reflection angle.

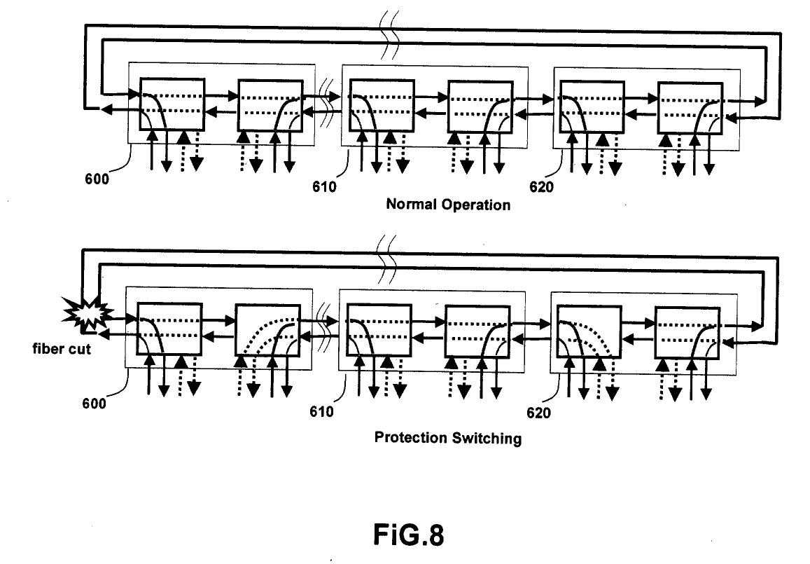

FIG. 8 shows an example of the optical layer automatic protection switching in an optical ring network. The optical ring consists of three ONE nodes of this invention, 600, 610, and 620. The upper diagram in FIG. 8 shows the traffic connections in the normal state, where a working wavelength (solid line) is used to set up three bi-directional working connections, one between two adjacent nodes. A protection wavelength (dotted line) is used for bi-directional shared protection (i.e., bi-directional path switched ring). When the fibers between the node 600 and the node 620 are cut, optical connections between the two nodes are broken. The destination nodes of the connections will detect the toss of signal (LOS) condition and initiate automatic protection switching. For the working wavelength connection in FIG. 8, the node 600 and the node 620 detect the loss of signal (LOS) condition and send APS request across the ring. The source node will turn on its redundant protection transponder and switch the protection wavelength channel mirror of the opposite side OADM module (relative to the failure side) to a new angle to reflect the protection wavelength to the destination node along the reverse direction in the ring. All intermediate nodes will bypass the protection wavelengths during the protection switching. In this way, the optical connection between the node 600 and the node 620 is reestablished by the bi-directional protection wavelength connection. The optical failure or degradation detection can be done at either the optical layer or the electrical layer. The spectrum monitor in the ONE can perform optical performance monitoring on every channel, and the optical performance parameters can be used to trigger the automatic protection switching if the performance threshold is crossed. The APS signaling channel is carried by the optical channel (OCH) overhead and the optical supervisory channel (OSC). After the fiber is repaired, the destination node will sense a valid working wavelength and then request to switch back to the normal operation mode. The source node will then bridge the signal back to the working wavelength, turn off the protection transponder, and switch the protection wavelength channel mirror in the OADM to the bypassing state. All this process is done automatically and controlled by the APS controller in the ONE node.

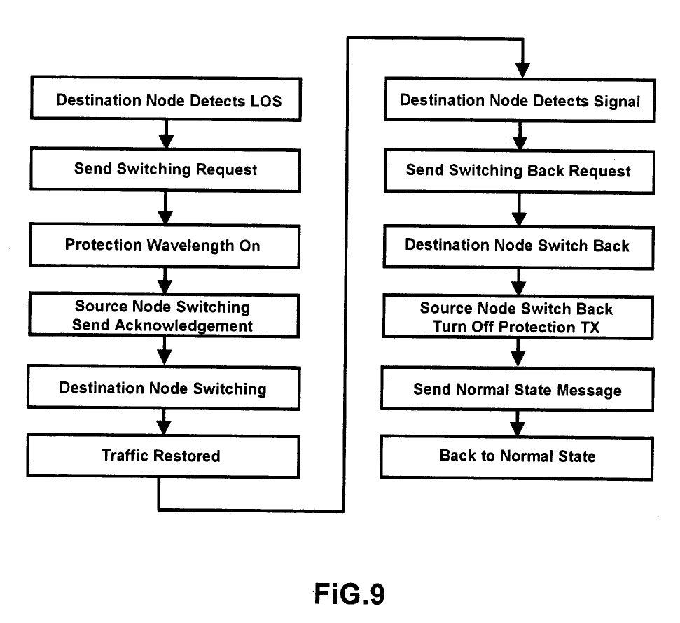

The flow chart of the optical layer protection switching control protocol is shown in FIG. 9. When a fiber between two adjacent nodes is cut, wavelength connections carried in this fiber are lost. The destination nodes will detect the failure and generate a loss of signal (LOS) alarm. It sends a protection-switching request along the ring through the optical supervisory channel. The source node will first bridge the traffic to the protection transmitter and tun it on, and then switch the MEMS channel mirror of the opposite-side OADM to reflect the protection wavelength from the protection add/drop port to the input/output port. The source ONE node will send a message to the destination node. Upon receiving the message, the destination node switches the channel mirror to a new angle to reflect the protection wavelength to the protection add/drop port. In this way, the lost connection between the two nodes is re-established. If the failed fiber is repaired, the destination node will detect a valid working wavelength channel. It will then request to switch back to the normal state. It first sends the switching request to the source node, waits for acknowledgement and then switches the channel mirror back to the normal state. It then sends the source node its new state message. The source node will turn off the protection transmitter and switch the protection wavelength mirror back to the bypassing state. Both the source node and the destination node are back to normal automatically in this way.

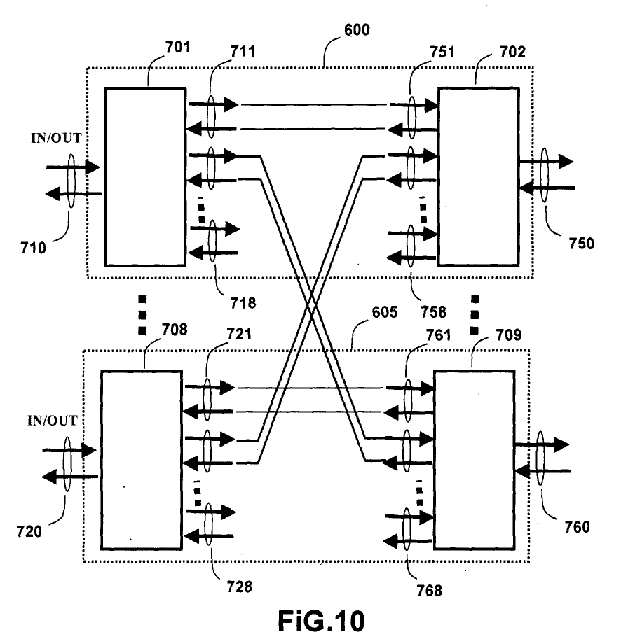

Architecture for multiple WDM ring interconnection is shown in FIG. 10. Each ONE node for the ring interconnection has two OADM modules of multiple add/drop ports. The OADM modules are cross-connected through bi-directional add/drop ports as shown in the figure. The OADM modules 701 and 702 of the first ONE node 600 are connected through the express input/output ports 711 and 751, the OADM modules 708 and 709 are connected through the express ports 721 and 761. Each OADM is connected to all other OADM by bi-directional connections. Six interconnections are needed for a two-node interconnection. FIG. 10 only shows two connections between the node 600 and the node 605. The connection between OADM modules 701 and 708 and the connection between the OADM modules 702 and 709 are not shown in the figure for simplicity. Multiple ring interconnection can be done in this way. It is conceivable that this ring interconnection architecture in FIG. 10 is a distributed optical cross-connect switch. Bi-directional wavelength connections can be routed from any input/output port to any input/output port. The optical rings can be cross-connected through the ONE nodes without the need for an additional expensive optical cross-connect (OXC) switch.

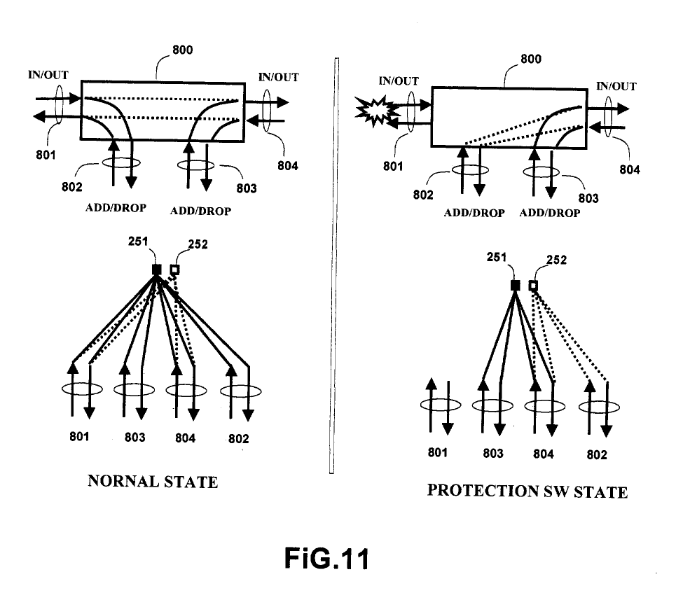

The standard ONE node architecture requires two bi-directional OADM modules as its O-NNI interfaces. In some applications where cost is the major concern, a dual-side OADM module 800 can be used to build low cost ONE. The dual-side OADM module is also a bi-directional OADM, but it only has four bi-directional port with special port assignment. The port assignment and internal connectivity of the dual-side bi-directional OADM 800 is shown in FIG. 11, where only a working wavelength and a protection wavelength are shown in the figure for simplicity. The internal wavelength connections in the normal state and in the protection-switching state are illustrated on the left side and the right side, respectively. When a working wavelength is reflected between the port 801 and the port 802, the same wavelength is also reflected between the port 803 and the port 804. Hence, four optical paths are established concurrently by the same channel mirror. Protection wavelengths and other passthrough wavelengths will bypass the node 800 from the port 801 to the port 804. When the west-side fiber is cut as indicated in the right side diagram in FIG. 11, the transmitter of the failed connection will be tuned to their protection wavelengths. A protection wavelength from the port 802 is reflected to the port 804 by adjusting the channel mirror to a new reflection angle. Connections can be reestablished by the protection-switching algorithm in FIG. 9, but transmitter wavelength tuning is required in this dual-side OADM case. The dual-side OADM can also be built to have a plurality of bi-directional add/drop ports per side. The dual-side OADM 800 can replace the two single-side OADM modules 400 and 405 in a ONE node in FIG. 6. Because the dual-side OADM is a single module based, replacement of the module will result in a loss of node failure for the WDM ring. Hence, the dual-side bi-directional OADM is only good for low-cost applications with reduced reliability.

The invention has been described with respect to particular embodiments thereof, it is understood that numerous modifications can be made without departing from the spirit and scope of the invention as set forth in the claims.

What is claimed is:

1. A bi-directional optical network element bi-directional WDM rings, comprising
(a) an east-side bi-directional OADM and a west-side bi-directional OADM with a plurality of bi-directional ports, and
(b) an east-side working OMUX/ODMUX, an east-side protection OMUX/ODMUX, a west-side working OMUX/ODMUX, and a west-side protection OMUX/ODMUX.

2. The method of claim 1, wherein the said bi-directional OADM consists of a 1-dimentional analog MEMS mirror array, an optional 2-dimentional MEMS port mirror array, a bulk grating, focusing lenses, and a plurality of bi-directional optical ports.

3. The method of claim 1, wherein the said OMUX/ODMUX device is optical multiplexers and optical demultiplexers that combines/separates WDM wavelengths.

4. The method of claim 1, wherein the said OADM has at least a bi-directional input/output port, a bi-directional express input/output port, a bi-directional working wavelength add/drop port, and a bi-directional protection wavelength add/drop port.

5. The method of claim 1, wherein the said working OMUX/ODMUX module is connected to the OADM module of the same side; and the said protection OMUX/ODMUX module is connected to the OADM module of the opposite side.

6. The method of claim 1, wherein WDM rings are interconnected by cross-connecting the said OADM modules in the nodes through their add/drop ports.

7. The method of claim 1, wherein the said optical network element connects the protection wavelength from the add/drop port to the input/output port of the opposite side OADM module during the automatic protection switching.

8. The method of claim 2, wherein optical ports in the said bi-directional OADM are within a linear port array and the ingress ports and the egress ports are interleaved along the array and symmetrically distributed.

9. The method of claim 2, wherein each MEMS channel mirror on the said 1D MEMS channel mirror array reflects a wavelength between any two bi-directional ports, or reflects a wavelength from the ingress port back to the egress port of the same bi-directional port for loopback.

10. The method of claim 2, wherein the said MEMS port mirror array is controlled by a dither based servo scheme for automatic optical alignment.

11. The method of claim 2, wherein the said bi-directional OADM is configurable as a dual-side bi-directional OADM with an east-side input/output port, one or a plurality of east-side add/drop ports, a west-side input/output port, and one or a plurality of west-side add/drop ports.

12. The method of claim 11, wherein a channel mirror in the dual-side bi-directional OADM concurrently reflects a wavelength between a said east-side add/drop port and the said east-side input/output port, and between a said west-side add/drop port and the said west-side input/output port.

13. The method of claim 10, wherein the said automatic port mirror alignment servo, comprising
(a) a reference wavelength source; and
(b) an ITU marker mirror on the MEMS channel mirror array to reflect the reference wavelength to different port; and
(c) a dither tone generator that is connected to the port mirror for dithering, and
(d) a spectrum monitor to generate error signal for the servo loop.

14. The method of claim 13, wherein the said reference wavelength is injected into the OADM device through the master ingress port and reflected back by the said ITU marker mirror to different port one by one.

15. The method of claim 13, wherein the port mirror is dithered by said dither tone generator to introduce intensity modulation on the reference wavelength.

16. The method of claim 15, wherein the dither induced intensity modulation on the reference wavelength is detected by the said spectrum monitor.
